(19) United States
(12) Patent Application Publication
(10) Pub. No.: US 2025/0233522 A1
(43) Pub. Date: Jul. 17, 2025

(54) Power Converter, Power Converter Controller, and Method of Controlling a Power Converter

(71) Applicant: Infineon Technologies Austria AG, Villach (AT)

(72) Inventor: Benjamim Tang, Rancho Palos Verdes, CA (US)

(21) Appl. No.: 18/411,903

(22) Filed: Jan. 12, 2024

(51) Int. Cl. H02M 3/335; H02M 1/00; H02M 3/00

(52) U.S. Cl. CPC H02M 3/33573; H02M 3/01; H02M 1/0058

(57) ABSTRACT

A power converter, power converter controller, and method of controlling a power converter are described. The power converter includes: a half bridge or full bridge switch network; an LLC resonant tank electrically coupled to the switch network; a rectifier circuit electrically coupled to a filter capacitor configured to provide a DC output voltage; a transformer inductively coupling the rectifier circuit to the LLC resonant tank; and a controller configured to determine a reference voltage to which the DC output voltage is regulated, and adjust a switching frequency of the switch network based on a difference between the DC output voltage and the reference voltage. The controller is configured to determine the reference voltage based on input voltage and/or output current feedback for the power converter and/or determine a variable switching frequency or a variable switching period for the switch network based on input voltage magnitude and output current magnitude.

### BACKGROUND

Resonant power converters are widely adopted for their inherent soft-switching capability, high efficiency, low EMI (electromagnetic interference), and high power density. Common resonant power converters topologies include series resonant converters, parallel resonant converters, and series-parallel resonant converters such as LCC and LLC converters.

The LLC power converter is a resonant converter where the DC input voltage is converted into a square wave by a switch network arranged as either a half or full bridge. The switch network feeds a resonant LLC tank that filters out harmonics and provides a sinusoidal like voltage and current waveform to a transformer. A rectifier circuit on the secondary side of the transformer converts the transformer AC current to a DC current that charges a filtering capacitor which in turn provides a DC output voltage. Converter power flow is controlled by modulating the square wave frequency (i.e. switching frequency) with respect to the resonance of the LLC tank. Resonant power converters provide a high conversion efficiency when operating near resonance, but have difficulty providing the required line (input) regulation and load (output) regulation over a wide operating range.

Unregulated LLC power converters have simple operation at a fixed frequency where efficiency is maximized but provide no line (input) regulation and no load (output) regulation. With no line regulation, in addition to the output voltage tracking the input voltage, there is no rejection of input ripple, and the input impedance is inherently negative, introducing stability concerns with the input filter.

Fixed output regulated LLC power converters provide line regulation and load regulation by maintaining the output voltage essentially constant independent of the input voltage and output load, but require large deviations in the switching frequency to maintain closed loop regulation. Fixed output regulated LLC power converters also suffer from poor stability at operating corners, and may require large resonant inductances to achieve a wide operating range.

Thus, there is a need for an improved LLC power converter, LLC power converter controller, and method of controlling an LLC power converter.

### SUMMARY

According to an embodiment of a power converter, the power converter comprises: a half bridge or full bridge switch network; an LLC resonant tank electrically coupled to the switch network; a rectifier circuit electrically coupled to a filter capacitor configured to provide a DC output voltage; a transformer inductively coupling the rectifier circuit to the LLC resonant tank; and a controller configured to determine a reference voltage to which the DC output voltage is regulated, and adjust a switching frequency of the switch network based on a difference between the DC output voltage and the reference voltage, wherein the controller is configured to determine the reference voltage based on input voltage and/or output current feedback for the power converter, such that the adjustment to the switching frequency is restricted as a function of an input voltage and/or an output current of the power converter.

According to an embodiment of a method of controlling a power converter that includes a half bridge or full bridge switch network, an LLC resonant tank electrically coupled to the switch network, a rectifier circuit electrically coupled to a filter capacitor configured to provide a DC output voltage, and a transformer inductively coupling the rectifier circuit to the LLC resonant tank, the method comprises: adjusting a switching frequency of the switch network based on a difference between the DC output voltage and a reference voltage to which the DC output voltage is regulated; and determining the reference voltage based on input voltage and/or output current feedback for the power converter, such that the adjustment to the switching frequency is restricted as a function of an input voltage and/or an output current of the power converter.

According to another embodiment of a power converter, the power converter comprises: a half bridge or full bridge switch network; an LLC resonant tank electrically coupled to the switch network; a rectifier circuit electrically coupled to a filter capacitor configured to provide a DC output voltage; a transformer inductively coupling the rectifier circuit to the LLC resonant tank; and a controller configured to determine a variable switching frequency or a variable switching period for the switch network based on input voltage magnitude and output current magnitude.

According to another embodiment of a method of controlling a power converter that includes a half bridge or full bridge switch network, an LLC resonant tank electrically coupled to the switch network, a rectifier circuit electrically coupled to a filter capacitor configured to provide a DC output voltage, and a transformer inductively coupling the rectifier circuit to the LLC resonant tank, the method comprises: receiving input voltage and/or output current feedback for the power converter; and determining a variable switching frequency or a variable switching period for the switch network based on input voltage magnitude and output current magnitude.

Those skilled in the art will recognize additional features and advantages upon reading the following detailed description, and upon viewing the accompanying drawings.

### BRIEF DESCRIPTION OF THE FIGURES

The elements of the drawings are not necessarily to scale relative to each other. Like reference numerals designate corresponding similar parts. The features of the various illustrated embodiments can be combined unless they exclude each other. Embodiments are depicted in the drawings and are detailed in the description which follows.

FIG. 1A illustrates a schematic diagram of a switch-mode DC/DC power converter, according to an embodiment.

FIG. 1B illustrates a more detailed view of both the switch network and the LLC resonant tank of the power converter.

FIG. 1C illustrates a gain curve for the power converter as a function of frequency (F) and load current, for different quality factor (Q) values.

FIG. 1D illustrates an equivalent resonant circuit for the LLC resonant tank gain.

FIG. 2 illustrates a schematic diagram of the switch-mode DC/DC power converter, according to another embodiment.

FIG. 3 illustrates a schematic diagram of the switch-mode DC/DC power converter, according to another embodiment.

FIG. 4 illustrates an embodiment of modifying a target voltage regulation setpoint for the power converter.

FIG. 5 illustrates another embodiment of modifying a target voltage regulation setpoint for the power converter.

FIG. 6 illustrates another embodiment of modifying a target voltage regulation setpoint for the power converter.

FIG. 7 illustrates another embodiment of modifying a target voltage regulation setpoint for the power converter.

FIG. 8 illustrates an embodiment of a control methodology according to which a variable switching frequency is implemented for the switch network of the power converter over the entire normal operating range of the power converter.

FIG. 9 illustrates an embodiment of a control methodology according to which a variable switching frequency is implemented for the switch network of the power converter outside a predetermined range of error voltages and a fixed switching frequency at resonance is implemented for the switch network within the predetermined range of error voltages.

FIG. 10 illustrates an embodiment of feedforward control implemented by the power converter controller.

FIG. 11 illustrates another embodiment of feedforward control implemented by the power converter controller.

### DETAILED DESCRIPTION

Described herein are power converter, power converter controller, and power converter control embodiments for improving usability of regulated and unregulated LLC power converters. Line (input) regulation and/or load (output) regulation targets may be controlled in a way that the resultant reference voltage dependence on input voltage magnitude and output (load) current magnitude restricts the frequency range of operation used to maintain regulation. This approach yields a systematically defined regulation performance with quantified performance bounds, and a narrower operating frequency range for higher efficiency and more constrained operation. Separately or in combination, feedforward control determined based on input voltage magnitude and output current magnitude may be used to determine a variable switching frequency or a variable switching period for a switch network on the input (primary) side of the power converter. The feedforward control may be used in both regulated and unregulated LLC power converters.

By defining the reference voltage over the operating range and in a way that allows closed loop operation over a narrower (restricted) operating frequency range, the power converter is operated closer to the efficiency achieved with resonant frequency operation, while allowing line regulation and/or load regulation targets to be met. The control methodology described herein allows the power converter output voltage to be regulated, if output voltage regulation is desired. For example, output voltage feedback may be used to generate an error voltage relative to the reference voltage. A compensator such as a PID (proportional-integral-derivative) controller may be used to drive the switching frequency of the switch network in a manner that regulates the output voltage to match the reference voltage.

Separately or in combination, the control methodology described herein may implement a block to compute the reference voltage or delta target voltage that accounts for a dependence on input voltage magnitude and output current magnitude. For example, an uncompensated target voltage regulation setpoint specified at a nominal input voltage and output current may be modified by a voltage adjustment magnitude so that the resulting reference voltage is a function of the voltage regulation setpoint, output current magnitude and/or input voltage magnitude and reduces the frequency deviation from the resonant frequency to achieve closed loop operation. This can be achieved, as needed, using a relationship that relates input voltage magnitude and/or output current magnitude to voltage adjustment magnitude for the target voltage regulation setpoint to achieve the desired line and/or load voltage regulation and restricted frequency operating range.

Compared to conventional fixed output voltage regulated power converters, the control methodology described herein provides a reduced frequency range to maintain regulation over a desired input voltage range and output current range, improves efficiency and power density through reduced frequency range requirements, provides the ability to adjust line and load regulation to application requirements, yields improved transient response to load current through matched voltage droop load line to output impedance, has improved overvoltage and overcurrent threshold tracking operating range, and improves anomaly detection through voltage correlation in multi-supply systems.

Compared to conventional fixed frequency unregulated power converters, the control methodology described herein reduces output voltage deviation due to line and load regulation, rejects input voltage ripple, has flexibility to trade off efficiency, line regulation, load regulation, input voltage range, output voltage range, and operating frequency range, and has improved (negative) input impedance, system stability, and simplified input filter design. Other advantages will become apparent as the various embodiments are described below in more detail.

Described next, with reference to the figures, are exemplary embodiments of the power converter, power converter controller, and power converter control embodiments.

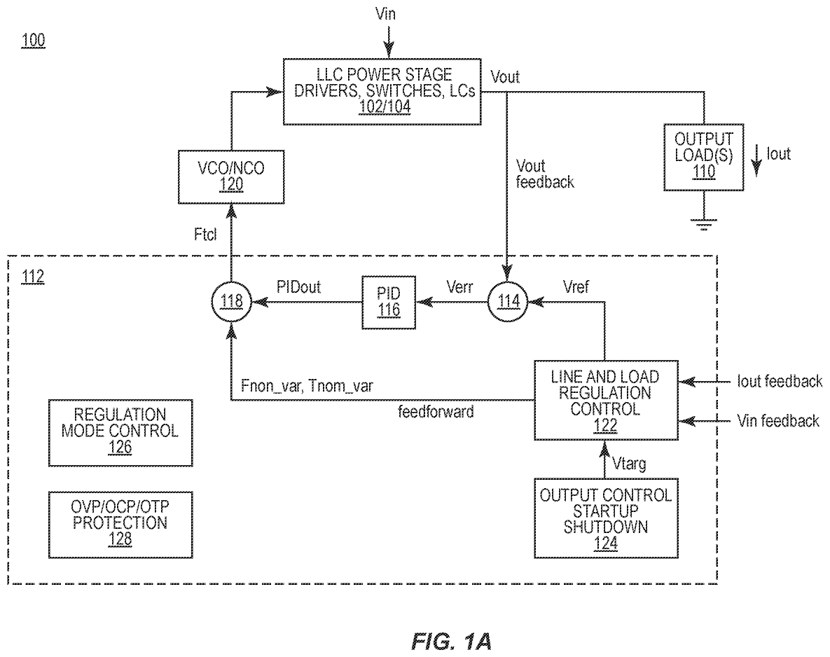

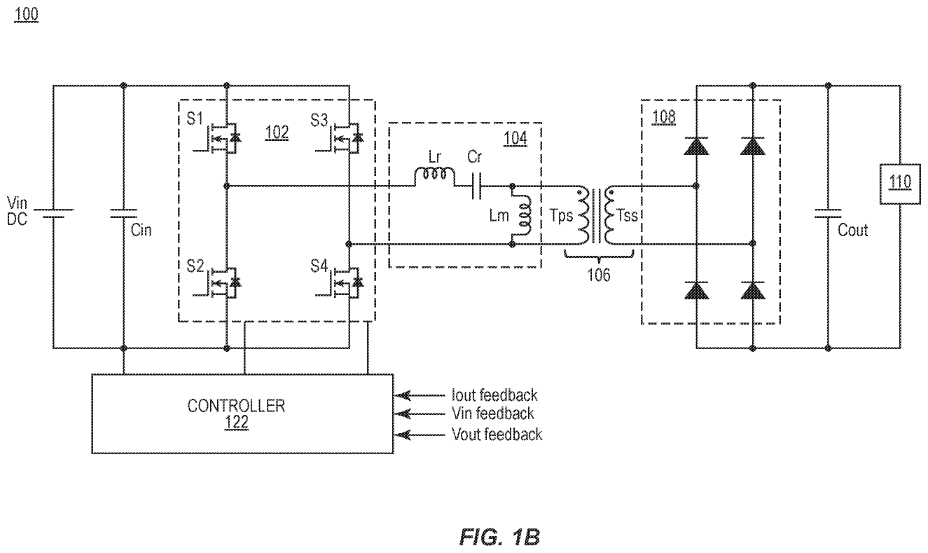

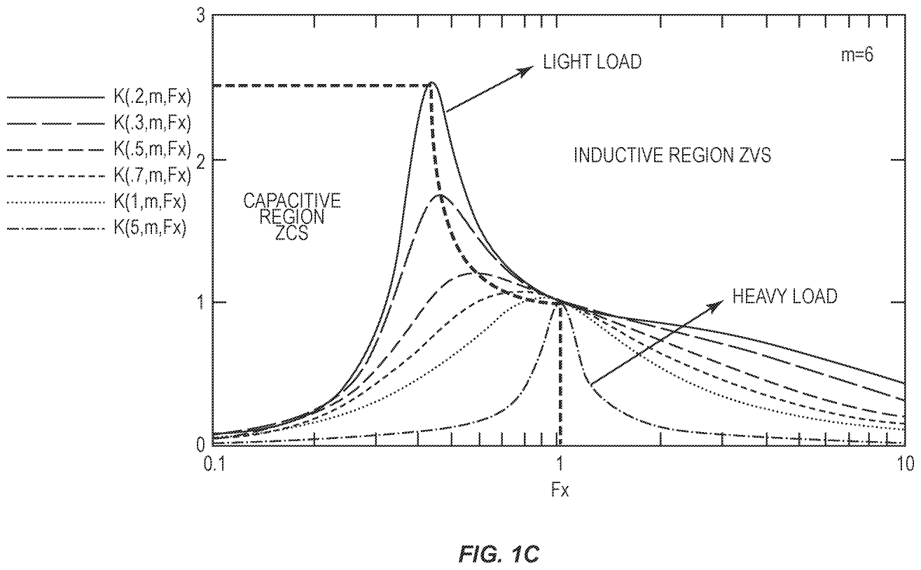

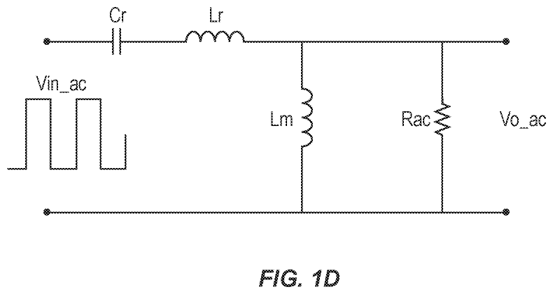

FIG. 1A illustrates a schematic diagram of a switch-mode DC/DC power converter 100, according to an embodiment. The power converter 100 may be regulated or unregulated and can be used in various power electronics applications that require high efficiency, wide input voltage range, and high power density, e.g., such as PC power supplies, server power supplies, telecom power supplies, flat panel TV and flat panel display power supplies, AC-DC adapters, electric vehicle charging, etc.

The power converter 100 includes a switch network 102 and an LLC resonant tank 104 electrically coupled to the switch network 102. FIG. 1A generically illustrates the switch network 102, the LLC resonant tank 104 and other related circuitry such as drivers, switches, transformer, etc., with FIG. 1B providing a more detailed view of both the switch network 102 and the LLC resonant tank 104.

The switch network 102 may be a full bridge switch network implemented using four switch devices S1 through S4 as shown in FIG. 1B, or a half bridge switch network where two of the switch devices (e.g., S1 and S2) are replaced with capacitors. The LLC resonant tank 104 includes two inductors Lm, Lr and a capacitor Cr. The primary inductor Lm is magnetically coupled to the secondary inductor Lr through a transformer 106, while the capacitor Cr of the LLC resonant tank 104 is in series with the secondary inductor Lr. The LLC resonant tank 104 oscillates at a specific frequency called resonance.

The transformer 106 includes a primary side winding Tps electrically coupled to the LLC resonant tank 104 and a secondary side winding Tss electrically coupled to a rectifier circuit 108. The switch network 102 generates a square waveform to excite the LLC resonant tank 104 which in turn outputs a resonant sinusoidal current that is scaled and rectified by the transformer 106 and the rectifier circuit 108. An output capacitor Cout on the secondary side filters the rectified ac current and outputs a DC voltage Vout to one or more loads 110. In FIG. 1B, the rectifier circuit 108 is implemented using a passive full bridge diode rectifier. However, the rectifier circuit 108 instead may be actively controlled. For example, the rectifier circuit 108 may be a synchronous rectifier with actively controlled switch devices. In each case, the rectifier circuit 108 is electrically coupled to the filter capacitor Cout which provides the DC output voltage Vout and the transformer 106 inductively couples the rectifier circuit 108 to the LLC resonant tank 104.

FIG. 1C illustrates the gain curve for the power converter 100 as a function of frequency (F) and load current, for different quality factor (Q) values. Operation at resonance frequency of the LLC tank 104 allows fixed gain and high efficiency through zero-voltage switching (ZVS) and zero-current switching (ZCS) to be achieved. Operation at frequencies beyond the resonance frequency allows the resonant tank gain (K) to be changed, so frequency modulation can be used to achieve closed loop regulation of the output voltage Vout.

The converter gain equals the gain of the switch network 102 times the gain of the LLC resonant tank 104 times the transformer turn ratio (Tps/Tss). The gain of the switch network 102 is 1 for a full bridge switch network implementation and 0.5 for a half bridge switch network implementation. The LLC resonant tank gain K can be derived by analyzing the equivalent resonant circuit shown in FIG. 1D. The LLC resonant tank gain K is the magnitude of its transfer function as given by:

$$K ( Q , m , Fx ) = \vert \frac{{V}_{o \_ ac} ( s )}{{V}_{in \_ ac} ( s )} \vert = \frac{{F}_{x}^{2} ( m - 1 )}{\sqrt{{( m * {F}_{x}^{2} - 1 )}^{2} + {Fx}^{2} * {( {F}_{x}^{2} - 1 )}^{2} * {( m - 1 )}^{2} * {Q}^{2}}} \qquad ( 1 )$$

where Q is the quality factor and is given by:

$$Q = \frac{\sqrt{{L}_{r} / {C}_{r}}}{Rac} , \qquad ( 2 )$$

Rac is the reflected load resistance and is given by:

$${R}_{ac} = \frac{8}{{π}^{2}} * \frac{{Tps}^{2}}{{Tss}^{2}} * {R}_{o} , \qquad ( 3 )$$

Fx is the normalized switching frequency and is given by:

$${F}_{x} = \frac{{f}_{s}}{{f}_{r}} , \qquad ( 4 )$$

fr is the resonance frequency and is given by:

$${f}_{r} = \frac{1}{\sqrt{2 π \sqrt{{L}_{r} * {C}_{r}}}} , \qquad ( 5 )$$

and m is the ratio of total primary inductance to resonance inductance and is given by:

$$m = \frac{{L}_{r} + {L}_{m}}{{L}_{r}} \qquad ( 6 )$$

As shown in FIG. 1C, low Q curves correspond to lighter load operation while higher Q curves correspond to heavier loads as the load resistance decreases with increased output current. All Q curves (load conditions) cross at the resonant frequency point (at Fx=1 or fs=fr) and are normalized to unity gain for reference in FIG. 1C.

The power converter 100 may be operated based on the concept of ZVS and ZCS, which help to minimize switching losses and improve efficiency. ZVS ensures that the voltage across the switch devices S1 through S4 is zero when the switch devices S1 through S4 are turned on. ZCS ensures that the current flowing through the switch devices S1 through S4 is zero when the switch devices S1 through S4 are turned off.

When the switching frequency of the power converter 100 is above the resonance frequency Fx of the LLC resonant tank 104, the power converter 100 operates in ZVS and provides efficient voltage conversion. When the switching frequency of the power converter 100 is below the resonance frequency Fx of the LLC resonant tank 104, the power converter 100 operates in ZCS with enhanced overall efficiency. The control method of an LLC resonant power converter typically involves adjusting the switching frequency to regulate the output voltage Vout. Such an approach maintains a high efficiency over a wide range of input voltages and load conditions but requires large deviations in the switching frequency to maintain closed loop regulation, suffers from poor stability at operating corners, and may require large resonant inductances to achieve a wide operating range.

The control methodology described herein provides a systematic, flexible approach which allows for balancing efficiency, operating frequency range, wide input range, and stable operation over the full load current range. In the case of the power converter 100 being operated as a regulated converter, the control methodology allows adjusting the line (input) and load (output) regulation capability of the power converter LLC to achieve the required frequency operating range. In the case of the power converter 100 being operated as a regulated or unregulated converter, the control methodology provides a feedforward control term that is calculated based on input voltage magnitude and output current magnitude and used to determine a variable switching frequency or a variable switching period for the switch network 102 on the input (primary) side of the power converter 100.

For regulated power converter operation, the converter controller 112 determines a reference voltage Vref to which the DC output voltage Vout is regulated and adjusts the switching frequency Fctl of the switch network 102 based on a difference Verr between the DC output voltage Vout and the reference voltage Vref. In FIG. 1A, the controller 112 is a digital controller implemented using digital circuitry and firmware. The controller 112 may be a microcontroller, for example.

The controller 112 includes a voltage difference calculator block 114 for calculating Verr based on the difference between Vout and Vref. A control loop mechanism 116 such as a PID (proportional-integral-derivative) controller applies a correction PIDout to the error voltage Verr based on proportional, integral, and derivative terms. Other types of control loop mechanisms may be used.

A frequency adjustment block 118 adjusts the switching frequency Fctl of the switch network 102 based on the correction PIDout to the error voltage Verr. The switching frequency Fctl is provided to a clock generator 120 such as a voltage controlled oscillator (VCO), a numerically controlled oscillator (NCO), etc. If the clock generator 120 is digital, the clock generator 120 may be part of the controller 112. The clock generator 120 provides a timing signal to the switch network 102, which synchronizes operation of the switch devices S1 through S4 at the switching frequency Fctl.

The controller 112 also includes line (input) and load (output) regulation logic 122 for determining the reference voltage Vref based on input voltage and/or output current feedback (‘Vin feedback’, ‘Iout feedback’) for the power converter 100. Accordingly, the adjustment to the switching frequency Fctl is restricted as a function of the DC input voltage Vin and/or the output current Iout of the power converter 100.

In one embodiment, the controller 112 includes output control, startup, and shutdown logic 124 that provides a target voltage regulation setpoint Vtarg to the line and load regulation logic 122. According to this embodiment, the line and load regulation logic 122 determines the reference voltage Vref by modifying the target voltage regulation setpoint Vtarg based on the input voltage and/or output current feedback. This allows the reference voltage Vref to be determined at a switching frequency Fctl that is closer to resonance of the LLC tank 104. The line and load regulation logic 122 or other controller logic may also determine a variable switching frequency Fnom_var or a variable switching period Tnom_var for the switch network 102 based on input voltage magnitude and output current magnitude.

The input voltage and output current feedback provided to the controller 112 indicates input voltage magnitude and output current magnitude. The input voltage and output current feedback may be sensed or measured Vin and Iout values, respectively. In another embodiment, the input voltage and output current feedback may be related to input voltage magnitude and output current magnitude, respectively. In FIGS. 1A and 1B, the controller 112 implements line (input) and load (output) regulation via the reference voltage Vref which restricts the amount of switching frequency adjustment, and also implements feedforward control via the variable switching frequency Fnom_var or variable switching period Tnom_var for the switch network 102. The controller 112 may also include regulation mode control logic 126 for determining whether the power converter 100 should operate in a regulated or unregulated state. The controller 112 may further include protection logic 128 for implementing one or more converter protection schemes such as overvoltage protection (OVP), overcurrent protection (OCP), overtemperature protection (OTP).

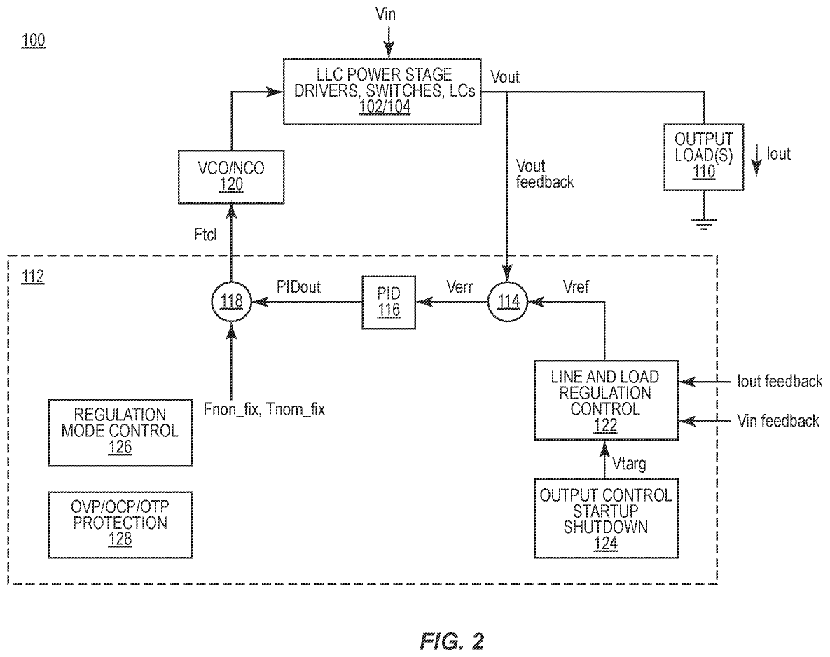

FIG. 2 illustrates a schematic diagram of the switch-mode DC/DC power converter 100, according to another embodiment. In FIG. 2, the controller 112 implements line (input) and load (output) regulation via the reference voltage Vref which restricts the amount of switching frequency adjustment, but does not implement the feedforward control. Instead, the embodiment of the controller 112 shown in FIG. 2 implements a fixed (resonance) switching frequency Fnom_fix or a fixed (resonance) switching period Tnom_nom for the switch network 102. The fixed switching frequency Fnom_fix (or the fixed switching period Tnom_nom) matches or is slightly higher than the resonance frequency (or resonance period) of the LLC resonant tank 104. According to the embodiment illustrated in FIG. 2, the controller 112 adjusts the fixed switching frequency Fnom_fix or the fixed switching period Tnom_nom based on the difference Verr between the DC output voltage Vout and the reference voltage Vref, to adjust the switching frequency Fctl of the switch network 102.

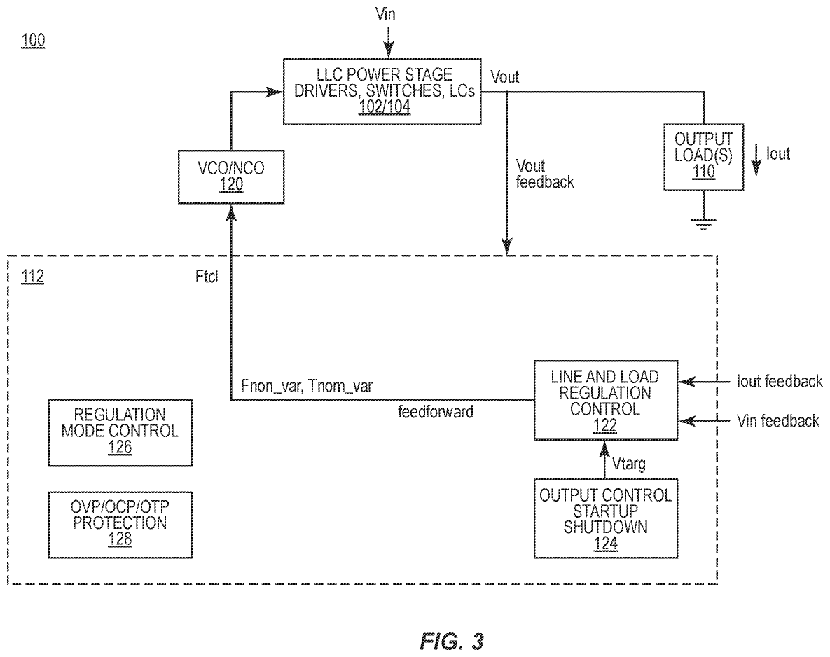

FIG. 3 illustrates a schematic diagram of the switch-mode DC/DC power converter 100, according to another embodiment. In FIG. 3, the controller 112 implements the feedforward control but not line (input) or load (output) regulation. According to this embodiment, the power converter 100 is operated in an unregulated mode but with tracking of the output voltage Vout. In FIG. 3, the controller 112 determines a variable switching frequency Fnom_var or a variable switching period Tnom_var of the switch network 102 based on input voltage magnitude and output current magnitude where the input voltage magnitude and the output current magnitude are indicated by the input voltage and output current feedback provided to the controller 112.

As previously explained herein, for the regulated power converter case, the controller 112 may determine the reference voltage Vref by modifying a target voltage regulation setpoint Vtarg based on the input voltage and/or output current feedback. This allows the reference voltage Vref to be determined at a switching frequency Fctl that is closer to resonance of the LLC tank 104.

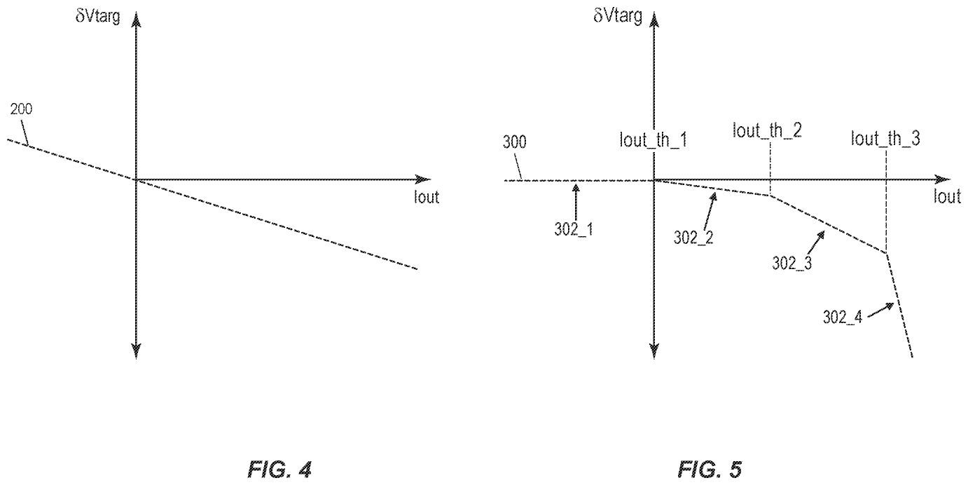

FIG. 4 illustrates an embodiment of the controller 112 modifying the target voltage regulation setpoint Vtarg based on a relationship 200 that relates output current (Iout) magnitude to voltage adjustment (δVtarg) magnitude for the target voltage regulation setpoint Vtarg. In FIG. 4, the relationship 200 is linear and has a negative slope. According to this embodiment, the magnitude of the adjustment δVtarg to the target voltage regulation setpoint Vtarg decreases linearly with increasing Iout magnitude and increases linearly with decreasing Iout magnitude.

FIG. 5 illustrates another embodiment of the controller 112 modifying the target voltage regulation setpoint Vtarg based on a relationship 300 that relates output current (Iout) magnitude to voltage adjustment (δVtarg) magnitude for the target voltage regulation setpoint Vtarg. In FIG. 5, the relationship 300 is a piecewise linear function defined by two or more straight-line segments 302 having different negative slopes that increase with increasing output current magnitude. Four (4) straight-line segments 302_1 through 302_4 are shown in FIG. 5, as an example. In FIG. 5, the gradient (slope) for δVtarg increases for higher Iout thresholds Iout_th and decreases for lower Iout thresholds Iout_th. The piecewise linear function may have zero slope for negative output current values as shown in FIF. 5, or a non-zero slope for negative output current values.

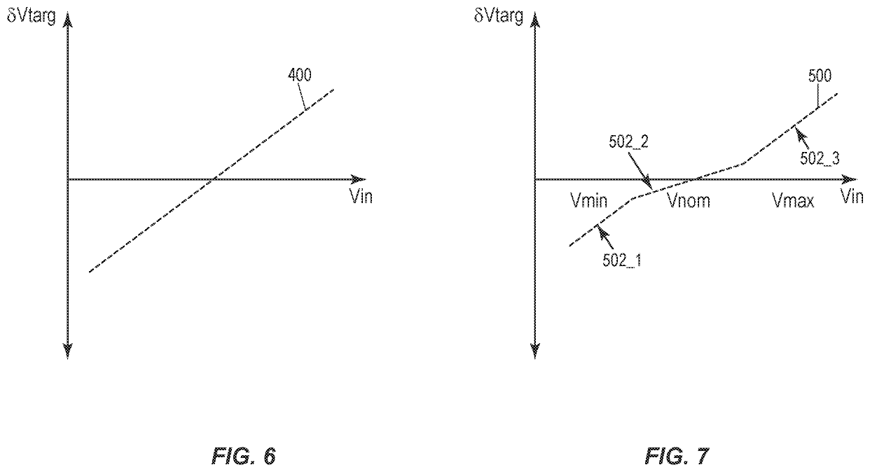

FIG. 6 illustrates another embodiment of the controller 112 modifying the target voltage regulation setpoint Vtarg based on a relationship 400 that relates input voltage (Vin) magnitude (Vin) to voltage adjustment (δVtarg) magnitude for the target voltage regulation setpoint Vtarg. In FIG. 6, the relationship 400 is linear and has a positive slope. A slope equal to the output/input voltage ratio is equal to 0% line (input) regulation. A slope of 0 is equal to 100% line regulation. A slope between these two extremes corresponds proportionally to the line regulation achieved, where the magnitude of the voltage adjustment δVtarg increases linearly with increasing Vin magnitude and decreases linearly with decreasing Vin magnitude.

FIG. 7 illustrates another embodiment of the controller 112 modifying the target voltage regulation setpoint Vtarg based on a relationship 500 that relates input voltage (Vin) magnitude to voltage adjustment (δVtarg) magnitude for the target voltage regulation setpoint Vtarg. In FIG. 7, the relationship 500 is a piecewise linear function defined by two or more straight-line segments 502 having different positive slopes. Three (3) straight-line segments 502_1 through 502_3 are shown in FIG. 7, as an example. In FIG. 7, the positive slope of a straight-line segment 502_2 that includes a nominal input voltage value ‘Vnom’ is shallower than the positive slope of each straight-line segment 502_1, 502_3 that does not include the nominal input voltage value Vnom. For example, the positive slope of a straight-line segment 502_1 that includes a minimum input voltage value ‘Vmin’ and the positive slope of a straight-line segment 502_3 that includes a maximum input voltage value ‘Vmax’ may both be steeper than the positive slope of the straight-line segment 502_2 that includes the nominal input voltage value Vnom. This allows for a greater degree of adjustment to the target voltage regulation setpoint Vtarg for input voltage magnitudes farther away from the nominal input voltage value Vnom and less adjustment for input voltage magnitudes closer to the nominal input voltage value Vnom.

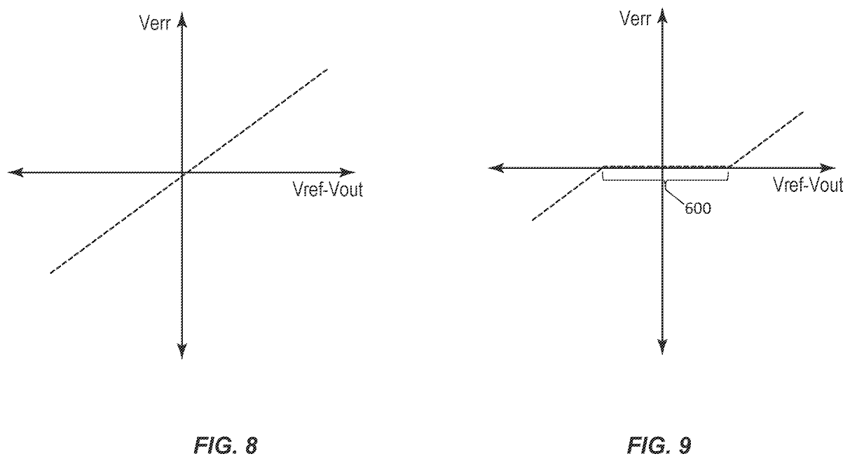

FIG. 8 illustrates an embodiment of the control methodology and according to which the controller 112 adjusts the switching frequency Fctl of the switch network 102 for differences (Vref-Vout) between the DC output voltage Vout and the reference voltage Vref over the entire normal operating range of the power converter 100. According to this embodiment, the controller 112 always operates the power converter in a regulated mode.

FIG. 9 illustrates an embodiment of the control methodology and according to which the controller 112 adjusts the switching frequency Fctl of the switch network 102 for differences (Vref−Vout) between the DC output voltage Vout and the reference voltage Vref that fall outside a predetermined range 600. The controller 112 uses a fixed frequency Fnom_fix or a fixed switching period Tnom_fix tuned to the resonance of the LLC resonant tank 104 as the switching frequency Fctl of the switch network for differences (Vref−Vout) between the DC output voltage Vout and the reference voltage Vref that fall within the predetermined range 600. According to this embodiment, the controller 112 operates the power converter in a regulated mode for Vref−Vout differences outside the predetermined range 600 and in an unregulated mode for Vref−Vout differences within the predetermined range 600.

The controller 112 may adopt a similar approach for the feedforward control. For example, the controller 112 may use a dead zone in computing the feedforward control, such that the power converter 100 has a frequency dependence on the difference Verr between the DC output voltage Vout and the reference voltage Vref without requiring a compensator to drive a control loop. Instead, the controller 112 may generate a frequency based on Verr (and optionally Iout and/or Vout), if desired.

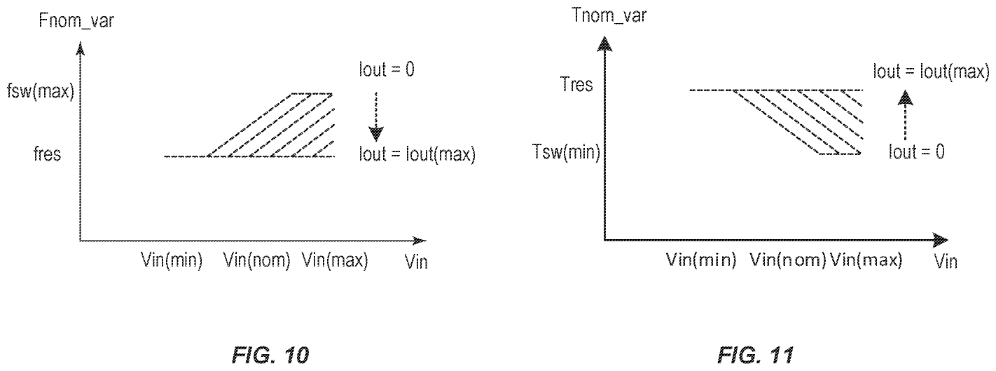

FIG. 10 illustrates an embodiment of the feedforward control implemented by the controller 112. According to this embodiment, the controller 112 determines a variable switching frequency Fnom_var for the switch network 102 based on input voltage (Vin) magnitude and output current (Iout) magnitude. If operating the power converter 100 in the regulated mode, the controller 112 also adjusts the variable switching frequency Fnom_var based on the difference between the DC output voltage Vout and the reference voltage Vref to adjust the switching frequency Fctl of the switch network 102.

In FIG. 10, the variable switching frequency Fnom_var is computed as a function of Vin and Iout. Vmin ranges from a minimum value Vin(min) to a maximum value Vin(max). Iout ranges from 0 to a maximum value Iout(max). The controller 112 may choose Fnom_var(Vin, Iout) in a way that minimizes the output voltage variation. For example, to reduce the LLC gain and keep the output voltage increase to within a target range, the controller 112 may increase the variable switching frequency Fnom_var for increasing input voltage (Vin) magnitude and decreasing output current (Iout) magnitude.

FIG. 11 illustrates another embodiment of the feedforward control implemented by the controller 112. According to this embodiment, the controller 112 determines a variable switching period Tnom_var for the switch network 102 based on input voltage (Vin) magnitude and output current (Iout) magnitude. If operating the power converter 100 in the regulated mode, the controller 112 also adjusts the variable switching period Tnom_var based on the difference between the DC output voltage Vout and the reference voltage Vref to adjust the switching period of the switch network 102.

In FIG. 11, the controller computes the variable switching period Tnom_var instead of a variable switching frequency Fnom_var, which may be a better fit to the nonlinearity in the gain curve shown in FIG. 1C. The controller 112 may choose Tnom_var(Vin, Iout) in a way that minimizes the output voltage variation. For example, to reduce the LLC gain and keep the output voltage increase to within a target range, the controller 112 may decrease the variable switching period Tnom_var for increasing input voltage (Vin) magnitude and decreasing output current (Iout) magnitude.

For the variable switching frequency Fnom_var and the variable switching period Tnom_var embodiments, the controller 112 may use piecewise linear approximations where the breakpoints are made a function of Vin and Iout. The piecewise linear approximations are indicated in FIGS. 10 and 11 by the parallel sloped dashed lines and the breakpoints are indicated by the lateral spaces between the parallel sloped dashed lines. Alternatively, the controller 112 may implement a look-up table with interpolation between table points to determine Fnom_var or Tnom_var as a function of Vin and Iout.

Although the present disclosure is not so limited, the following numbered examples demonstrate one or more aspects of the disclosure.

Example 1. A power converter, comprising: a half bridge or full bridge switch network; an LLC resonant tank electrically coupled to the switch network; a rectifier circuit electrically coupled to a filter capacitor configured to provide a DC output voltage; a transformer inductively coupling the rectifier circuit to the LLC resonant tank; and a controller configured to determine a reference voltage to which the DC output voltage is regulated, and adjust a switching frequency of the switch network based on a difference between the DC output voltage and the reference voltage, wherein the controller is configured to determine the reference voltage based on input voltage and/or output current feedback for the power converter, such that the adjustment to the switching frequency is restricted as a function of an input voltage and/or an output current of the power converter.

Example 2. The power converter of example 1, wherein the controller is configured to determine the reference voltage by modifying a target voltage regulation setpoint based on the input voltage and/or output current feedback.

Example 3. The power converter of example 2, wherein the controller is configured to modify the target voltage regulation setpoint based on a relationship that relates output current magnitude to voltage adjustment magnitude for the target voltage regulation setpoint.

Example 4. The power converter of example 3, wherein the relationship is a linear function defined by a straight line having a negative slope.

Example 5. The power converter of example 3, wherein the relationship is a piecewise linear function defined by two or more straight-line segments having different negative slopes that increase with increasing output current magnitude.

Example 6. The power converter of any of examples 2 through 5, wherein the controller is configured to modify the target voltage regulation setpoint based on a relationship that relates input voltage magnitude to voltage adjustment magnitude for the target voltage regulation setpoint.

Example 7. The power converter of example 6, wherein the relationship is linear and has a positive slope.

Example 8. The power converter of example 6, wherein the relationship is piecewise linear and has two or more straight-line segments having different positive slopes.

Example 9. The power converter of example 8, wherein the positive slope of a straight-line segment that includes a nominal input voltage value is shallower than the positive slope of a straight-line segment that does not include the nominal input voltage value.

Example 10. The power converter of example 8 or 9, wherein the piecewise linear function has zero slope for negative output current values.

Example 11. The power converter of example 8 or 9, wherein the piecewise linear function has a non-zero slope for negative output current values.

Example 12. The power converter of any of examples 1 through 11, wherein the controller is configured to adjust the switching frequency of the switch network for differences between the DC output voltage and the reference voltage that fall outside a predetermined range, and wherein the controller is configured to use a fixed frequency tuned to a resonance of the LLC resonant tank as the switching frequency of the switch network for differences between the DC output voltage and the reference voltage that fall within the predetermined range.

Example 13. The power converter of any of examples 1 through 12, wherein the controller is configured to determine a variable switching frequency or a variable switching period for the switch network based on input voltage magnitude and output current magnitude, and wherein the controller is configured to adjust the variable switching frequency or the variable switching period based on the difference between the DC output voltage and the reference voltage to adjust the switching frequency of the switch network.

Example 14. The power converter of example 13, wherein the controller is configured to increase the variable switching frequency or decrease the variable switching period for increasing input voltage magnitude and decreasing output current magnitude.

Example 15. A method of controlling a power converter that includes a half bridge or full bridge switch network, an LLC resonant tank electrically coupled to the switch network, a rectifier circuit electrically coupled to a filter capacitor configured to provide a DC output voltage, and a transformer inductively coupling the rectifier circuit to the LLC resonant tank, the method comprising: adjusting a switching frequency of the switch network based on a difference between the DC output voltage and a reference voltage to which the DC output voltage is regulated; and determining the reference voltage based on input voltage and/or output current feedback for the power converter, such that the adjustment to the switching frequency is restricted as a function of an input voltage and/or an output current of the power converter.

Example 16. The method of example 15, wherein determining the reference voltage comprises: modifying a target voltage regulation setpoint based on the input voltage and/or output current feedback.

Example 17. The method of example 16, wherein modifying the target voltage regulation setpoint comprises: modifying the target voltage regulation setpoint based on a relationship that relates output current magnitude to voltage adjustment magnitude for the target voltage regulation setpoint.

Example 18. The method of example 17, wherein the relationship is a linear function defined by a straight line having a negative slope.

Example 19. The method of example 17, wherein the relationship is a piecewise linear function defined by two or more straight-line segments having different negative slopes that increase with increasing output current magnitude.

Example 20. The method of any of examples 16 through 19, wherein modifying the target voltage regulation setpoint comprises: modifying the target voltage regulation setpoint based on a relationship that relates input voltage magnitude to voltage adjustment magnitude for the target voltage regulation setpoint.

Example 21. The method of example 20, wherein the relationship is linear and has a positive slope.

Example 22. The method of example 20, wherein the relationship is piecewise linear and has two or more straight-line segments having different positive slopes.

Example 23. The method of example 22, wherein the positive slope of a straight-line segment that includes a nominal input voltage value is shallower than the positive slope of a straight-line segment that does not include the nominal input voltage value.

Example 24. The method of any of examples 15 through 23, wherein adjusting the switching frequency of the switch network comprises: adjusting the switching frequency of the switch network for differences between the DC output voltage and the reference voltage that fall outside a predetermined range; using a fixed frequency tuned to a resonance of the LLC resonant tank as the switching frequency of the switch network for differences between the DC output voltage and the reference voltage that fall within the predetermined range.

Example 25. The method of any of examples 15 through 24, further comprising: determining a variable switching frequency or a variable switching period for the switch network based on input voltage magnitude and output current magnitude; and adjusting the variable switching frequency or the variable switching period based on the difference between the DC output voltage and the reference voltage to adjust the switching frequency of the switch network.

Example 26. The method of example 25, wherein determining the variable switching frequency or the variable switching period based on input voltage magnitude and output current magnitude comprises: increasing the variable switching frequency or decreasing the variable switching period for increasing input voltage magnitude and decreasing output current magnitude.

Example 27. A power converter, comprising: a half bridge or full bridge switch network; an LLC resonant tank electrically coupled to the switch network; a rectifier circuit electrically coupled to a filter capacitor configured to provide a DC output voltage; a transformer inductively coupling the rectifier circuit to the LLC resonant tank; and a controller configured to determine a variable switching frequency or a variable switching period for the switch network based on input voltage magnitude and output current magnitude.

Example 28. The power converter of example 27, wherein the controller is configured to adjust the variable switching frequency or the variable switching period based on a difference between the DC output voltage and a reference voltage such that the DC output voltage is regulated.

Example 29. The power converter of example 28, wherein the controller is configured to determine the reference voltage based on the input voltage and/or output current feedback, such that the adjustment to the variable switching frequency or the variable switching period is restricted as a function of an input voltage and/or an output current of the power converter.

Example 30. The power converter of any of examples 27 through 29, wherein the controller is configured to increase the variable switching frequency or decrease the variable switching period for increasing input voltage magnitude and decreasing output current magnitude.

Example 31. A method of controlling a power converter that includes a half bridge or full bridge switch network, an LLC resonant tank electrically coupled to the switch network, a rectifier circuit electrically coupled to a filter capacitor configured to provide a DC output voltage, and a transformer inductively coupling the rectifier circuit to the LLC resonant tank, the method comprising: receiving input voltage and/or output current feedback for the power converter; and determining a variable switching frequency or a variable switching period for the switch network based on input voltage magnitude and output current magnitude.

Example 32. The method of example 31, further comprising: adjusting the variable switching frequency or the variable switching period based on a difference between the DC output voltage and a reference voltage such that the DC output voltage is regulated.

Example 33. The method of example 32, further comprising: determining the reference voltage based on the input voltage and/or output current feedback, such that the adjustment to the variable switching frequency or the variable switching period is restricted as a function of an input voltage and/or an output current of the power converter.

Example 34. The method of any of examples 31 through 33, wherein determining the variable switching frequency or the variable switching period based on input voltage magnitude and output current magnitude comprises: increasing the variable switching frequency or decreasing the variable switching period for increasing input voltage magnitude and decreasing output current magnitude.

Terms such as “first”, “second”, and the like, are used to describe various elements, regions, sections, etc. and are also not intended to be limiting. Like terms refer to like elements throughout the description.

As used herein, the terms “having”, “containing”, “including”, “comprising” and the like are open ended terms that indicate the presence of stated elements or features, but do not preclude additional elements or features. The articles “a”, “an” and “the” are intended to include the plural as well as the singular, unless the context clearly indicates otherwise.

The expression “and/or” should be interpreted to cover all possible conjunctive and disjunctive combinations, unless expressly noted otherwise. For example, the expression “A and/or B” should be interpreted to mean only A, only B, or both A and B. The expression “at least one of” should be interpreted in the same manner as “and/or”, unless expressly noted otherwise. For example, the expression “at least one of A and B” should be interpreted to mean only A, only B, or both A and B.

It is to be understood that the features of the various embodiments described herein can be combined with each other, unless specifically noted otherwise.

Although specific embodiments have been illustrated and described herein, it will be appreciated by those of ordinary skill in the art that a variety of alternate and/or equivalent implementations can be substituted for the specific embodiments shown and described without departing from the scope of the present invention. This application is intended to cover any adaptations or variations of the specific embodiments discussed herein. Therefore, it is intended that this invention be limited only by the claims and the equivalents thereof.

What is claimed is:

1. A power converter, comprising:
a half bridge or full bridge switch network;
an LLC resonant tank electrically coupled to the switch network;
a rectifier circuit electrically coupled to a filter capacitor configured to provide a DC output voltage;
a transformer inductively coupling the rectifier circuit to the LLC resonant tank; and
a controller configured to determine a reference voltage to which the DC output voltage is regulated, and adjust a switching frequency of the switch network based on a difference between the DC output voltage and the reference voltage,
wherein the controller is configured to determine the reference voltage based on input voltage and/or output current feedback for the power converter, such that the adjustment to the switching frequency is restricted as a function of an input voltage and/or an output current of the power converter.

2. The power converter of claim 1, wherein the controller is configured to determine the reference voltage by modifying a target voltage regulation setpoint based on the input voltage and/or output current feedback.

3. The power converter of claim 2, wherein the controller is configured to modify the target voltage regulation setpoint based on a relationship that relates output current magnitude to voltage adjustment magnitude for the target voltage regulation setpoint.

4. The power converter of claim 3, wherein the relationship is a linear function defined by a straight line having a negative slope.

5. The power converter of claim 3, wherein the relationship is a piecewise linear function defined by two or more straight-line segments having different negative slopes that increase with increasing output current magnitude.

6. The power converter of claim 2, wherein the controller is configured to modify the target voltage regulation setpoint based on a relationship that relates input voltage magnitude to voltage adjustment magnitude for the target voltage regulation setpoint.

7. The power converter of claim 6, wherein the relationship is linear and has a positive slope.

8. The power converter of claim 6, wherein the relationship is piecewise linear and has two or more straight-line segments having different positive slopes.

9. The power converter of claim 8, wherein the positive slope of a straight-line segment that includes a nominal input voltage value is shallower than the positive slope of a straight-line segment that does not include the nominal input voltage value.

10. The power converter of claim 1, wherein the controller is configured to adjust the switching frequency of the switch network for differences between the DC output voltage and the reference voltage that fall outside a predetermined range, and wherein the controller is configured to use a fixed frequency tuned to a resonance of the LLC resonant tank as the switching frequency of the switch network for differences between the DC output voltage and the reference voltage that fall within the predetermined range.

11. The power converter of claim 1, wherein the controller is configured to determine a variable switching frequency or a variable switching period for the switch network based on input voltage magnitude and output current magnitude, and wherein the controller is configured to adjust the variable switching frequency or the variable switching period based on the difference between the DC output voltage and the reference voltage to adjust the switching frequency of the switch network.

12. The power converter of claim 11, wherein the controller is configured to increase the variable switching frequency or decrease the variable switching period for increasing input voltage magnitude and decreasing output current magnitude.

13. A method of controlling a power converter that includes a half bridge or full bridge switch network, an LLC resonant tank electrically coupled to the switch network, a rectifier circuit electrically coupled to a filter capacitor configured to provide a DC output voltage, and a transformer inductively coupling the rectifier circuit to the LLC resonant tank, the method comprising:
adjusting a switching frequency of the switch network based on a difference between the DC output voltage and a reference voltage to which the DC output voltage is regulated; and
determining the reference voltage based on input voltage and/or output current feedback for the power converter, such that the adjustment to the switching frequency is restricted as a function of an input voltage and/or an output current of the power converter.

14. The method of claim 13, wherein determining the reference voltage comprises:
modifying a target voltage regulation setpoint based on the input voltage and/or output current feedback.

15. The method of claim 14, wherein modifying the target voltage regulation setpoint comprises:
modifying the target voltage regulation setpoint based on a relationship that relates output current magnitude to voltage adjustment magnitude for the target voltage regulation setpoint.

16. The method of claim 15, wherein the relationship is a linear function defined by a straight line having a negative slope.

17. The method of claim 15, wherein the relationship is a piecewise linear function defined by two or more straight-line segments having different negative slopes that increase with increasing output current magnitude.

18. The method of claim 14, wherein modifying the target voltage regulation setpoint comprises:
modifying the target voltage regulation setpoint based on a relationship that relates input voltage magnitude to voltage adjustment magnitude for the target voltage regulation setpoint.

19. The method of claim 18, wherein the relationship is linear and has a positive slope.

20. The method of claim 18, wherein the relationship is piecewise linear and has two or more straight-line segments having different positive slopes.

21. The method of claim 20, wherein the positive slope of a straight-line segment that includes a nominal input voltage value is shallower than the positive slope of a straight-line segment that does not include the nominal input voltage value.

22. The method of claim 13, wherein adjusting the switching frequency of the switch network comprises:
adjusting the switching frequency of the switch network for differences between the DC output voltage and the reference voltage that fall outside a predetermined range; and
using a fixed frequency tuned to a resonance of the LLC resonant tank as the switching frequency of the switch network for differences between the DC output voltage and the reference voltage that fall within the predetermined range.

23. The method of claim 13, further comprising:
determining a variable switching frequency or a variable switching period for the switch network based on input voltage magnitude and output current magnitude; and
adjusting the variable switching frequency or the variable switching period based on the difference between the DC output voltage and the reference voltage to adjust the switching frequency of the switch network.

24. The method of claim 23, wherein determining the variable switching frequency or the variable switching period based on input voltage magnitude and output current magnitude comprises:
increasing the variable switching frequency or decreasing the variable switching period for increasing input voltage magnitude and decreasing output current magnitude.

25. A power converter, comprising:
a half bridge or full bridge switch network;
an LLC resonant tank electrically coupled to the switch network;
a rectifier circuit electrically coupled to a filter capacitor configured to provide a DC output voltage;
a transformer inductively coupling the rectifier circuit to the LLC resonant tank; and
a controller configured to determine a variable switching frequency or a variable switching period for the switch network based on input voltage magnitude and output current magnitude.

26. The power converter of claim 25, wherein the controller is configured to adjust the variable switching frequency or the variable switching period based on a difference between the DC output voltage and a reference voltage such that the DC output voltage is regulated.

27. The power converter of claim 26, wherein the controller is configured to determine the reference voltage based on the input voltage and/or output current feedback, such that the adjustment to the variable switching frequency or the variable switching period is restricted as a function of an input voltage and/or an output current of the power converter.

28. The power converter of claim 25, wherein the controller is configured to increase the variable switching frequency or decrease the variable switching period for increasing input voltage magnitude and decreasing output current magnitude.

29. A method of controlling a power converter that includes a half bridge or full bridge switch network, an LLC resonant tank electrically coupled to the switch network, a rectifier circuit electrically coupled to a filter capacitor configured to provide a DC output voltage, and a transformer inductively coupling the rectifier circuit to the LLC resonant tank, the method comprising:
receiving input voltage and/or output current feedback for the power converter; and
determining a variable switching frequency or a variable switching period for the switch network based on input voltage magnitude and output current magnitude.

30. The method of claim 29, further comprising:
adjusting the variable switching frequency or the variable switching period based on a difference between the DC output voltage and a reference voltage such that the DC output voltage is regulated.

31. The method of claim 30, further comprising:
determining the reference voltage based on the input voltage and/or output current feedback, such that the adjustment to the variable switching frequency or the variable switching period is restricted as a function of an input voltage and/or an output current of the power converter.

32. The method of claim 29, wherein determining the variable switching frequency or the variable switching period based on input voltage magnitude and output current magnitude comprises:
increasing the variable switching frequency or decreasing the variable switching period for increasing input voltage magnitude and decreasing output current magnitude.
